(19) United States
(12) Patent Application Publication
(10) Pub. No.: US 2026/0104025 A1
(43) Pub. Date: Apr. 16, 2026

(54) FUEL FILTER

(71) Applicant: MAHLE International GmbH, Stuttgart (DE)

(72) Inventors: Cristian Cristache, Pitesti (RO); Sorin Jadaneantu, Timis (RO)

(21) Appl. No.: 19/356,037

(22) Filed: Oct. 10, 2025

(30) Foreign Application Priority Data
Oct. 11, 2024 (DE) 102024129394.2

(51) Int. Cl. F02M 37/34; B01D 27/08; B01D 29/15

(52) U.S. Cl. CPC F02M 37/34; B01D 27/08; B01D 29/15; B01D 2201/347; B01D 2201/40

(57) ABSTRACT

A fuel filter for a motor vehicle may include a housing, a hollow-cylindrical filter element arranged coaxially in the housing, a hollow-cylindrical outlet neck arranged coaxially in the filter element, and a sealing tube arranged between the filter element and the outlet neck coaxially to the outlet neck. The sealing tube may be fluid-tightly connected to the filter element at a first longitudinal end of the housing and may bear in a fluid-tight manner against the outlet neck at an axial distance from the first longitudinal end of the housing. The housing may include an outwardly leading outlet disposed at the first longitudinal end. The outlet neck may be, at the first longitudinal end of the housing, fluidically connected to the outlet. The outlet neck may include at least one axially extending groove facing the sealing tube.

### CROSS-REFERENCE TO RELATED APPLICATION

This application claims priority to German Patent Application No. DE102024129394.2, filed on Oct. 11, 2024, the contents of which is hereby incorporated by reference.

### TECHNICAL FIELD

The invention relates to a fuel filter for a motor vehicle.

### BACKGROUND

A fuel filter for filtering a fuel usually comprises a housing and a filter element arranged in the housing. The filter element divides the housing into a filtered fluid region and an unfiltered fluid region. If the filter element is annular in shape, the unfiltered fluid region is usually on the outside of the filter element, and the filtered fluid region is inside the filter element. The fuel then flows through the filter element from the outside to the inside, and is filtered. To allow the filtered fuel to flow out, an outlet neck may be provided which engages in the filtered fluid region inside the filter element and guides the fuel to the outside. Sealing the outlet neck to other elements of the fuel filter is important here.

### SUMMARY

It is therefore an object of the invention to provide, for a fuel filter of the generic type, an improved or at least alternative embodiment by which the disadvantages described are overcome.

According to the invention, this object is achieved by the subject matter of independent claim(s). Advantageous embodiments are the object of the dependent claim(s).

The fuel filter according to the invention is intended or configured for a motor vehicle. The fuel filter comprises a housing that comprises an axial first longitudinal end and an axial second longitudinal end in relation to its longitudinal central axis. Furthermore, the fuel filter comprises a hollow-cylindrical filter element and a hollow-cylindrical outlet neck and a sealing tube. The filter element in the housing is arranged coaxially to said housing and the outlet neck in the filter element is arranged coaxially to said housing and the sealing tube is arranged between the filter element and the outlet neck coaxially to said housing. The sealing tube is connected to the filter element in a fluid-tight manner at the first longitudinal end of the housing and lies against the outlet neck in a fluid-tight manner at an axial distance from the first longitudinal end of the housing. The housing comprises an outwardly leading outlet at its first longitudinal end and the outlet neck is in fluid communication with the outlet at the first longitudinal end of the housing. The outlet neck further comprises at least one axially extending groove, which is formed on the outlet neck facing the sealing tube.

In the fuel filter according to the invention, the outlet neck in the sealing tube and the sealing tube in the filter element and the filter element in the housing are arranged coaxially. The at least one groove is arranged between the outlet neck and the sealing tube such that the outlet neck and the sealing tube may be arranged at a minimum radial distance from each other without a vacuum/air-lock effect. As a result, a dead volume between the outlet neck and the sealing tube may be minimized without the sealing of the outlet neck and the sealing tube to each other being affected by the vacuum/air-lock effect. As the fuel in the dead volume is not filtered and not used, losses in the fuel filter may be minimized.

The at least one groove may extend axially over at least 25%, preferably over at least 50%, particularly preferably over at least 75%, of an axial height of an annular cavity of the fuel filter formed between the sealing tube and the outlet neck. The at least one groove may, in particular, extend over 100% of an axial height of an annular cavity of the fuel filter formed between the sealing tube and the outlet neck. In other words, the at least one groove may extend over an entire axial height of an annular cavity of the fuel filter formed between the sealing tube and the outlet neck. This may prevent the vacuum/air-lock effect over the entire axial height of the cavity.

The outlet neck may comprise a plurality of grooves. In particular, the outlet neck may comprise exactly two or exactly three or exactly four or exactly five or exactly six or more grooves. The grooves may then be formed distributed around the longitudinal central axis of the housing on the outlet neck. The plurality of grooves may be formed evenly distributed around the longitudinal central axis of the housing. In other words, the grooves may have an identical distance to one another along a circumferential direction encircling the longitudinal central axis of the housing.

The plurality of grooves may be identical to each other. In other words, the grooves may comprise an identical axial height and/or an identical circumferentially defined width and/or an identical radially defined depth. A cross section of the grooves, which is oriented transversely to the longitudinal central axis, may also be identical.

The fuel filter may comprise an unfiltered fluid space formed between the housing and the filter element. The unfiltered fluid space may surround the filter element, at least on the outside. Furthermore, the fuel filter may comprise an annular cavity formed between the sealing tube and the outlet neck. The cavity may be in fluid communication with the unfiltered fluid space at the first longitudinal end of the housing. The cavity may define a dead volume between the outlet neck and the sealing tube. The fuel in the dead volume is not filtered and not used. The dead volume may be minimized by reducing the radial distance between the sealing tube and the outlet neck. The grooves of the outlet neck are open in the cavity and prevent a vacuum/air-lock effect in the cavity or between the outlet neck and the sealing tube.

The outlet neck may comprise an inlet opening facing away from the first longitudinal end of the housing. The sealing tube may lie fluid-tight against the outlet neck between the inlet opening and the first longitudinal end of the housing. As a result, the inlet opening may fluidly open into a filtered fluid space arranged within the filter element and be sealed off from the cavity, which is in fluid communication with the unfiltered fluid space, between the outlet neck and the sealing tube.

The sealing tube may bear in a sealing manner against the outlet neck, in particular in a circumferential sealing region of the outlet neck, thereby forming a sealing seat between the sealing tube and the outlet neck. The fuel filter may then comprise a ring seal that seals the sealing seat. Advantageously, the at least one groove may extend axially to the sealing seat.

In the context of the present invention, the terms “axial” and “radial” and “circumferential” and “coaxial”always refer to the longitudinal central axis of the housing.

Further important features and advantages of the invention will become apparent from the dependent claims, from the drawings, and from the associated description of the figures with reference to the drawings.

It is understood that the features mentioned above and those to be explained below may be used not only in the combination indicated in each case, but also in other combinations or on their own, without departing from the scope of the present invention.

Preferred exemplary embodiments of the invention are shown in the drawings by way of example and are explained in more detail in the following description, wherein identical reference signs refer to identical or similar or functionally identical elements.

### BRIEF DESCRIPTION OF THE DRAWINGS

It shows, schematically in each case

FIG. 1 shows a sectional view of a fuel filter according to the invention;

FIG. 2 shows a sectional view of the fuel filter according to the invention in the region of a sealing location outside of a groove;

FIG. 3 shows a sectional view of the fuel filter according to the invention in the region of the sealing seat through the groove;

FIG. 4 shows a view of the fuel filter according to the invention without a housing and partially without a filter element;

FIG. 5 shows a view of an outlet neck of the fuel filter according to the invention.

### DETAILED DESCRIPTION

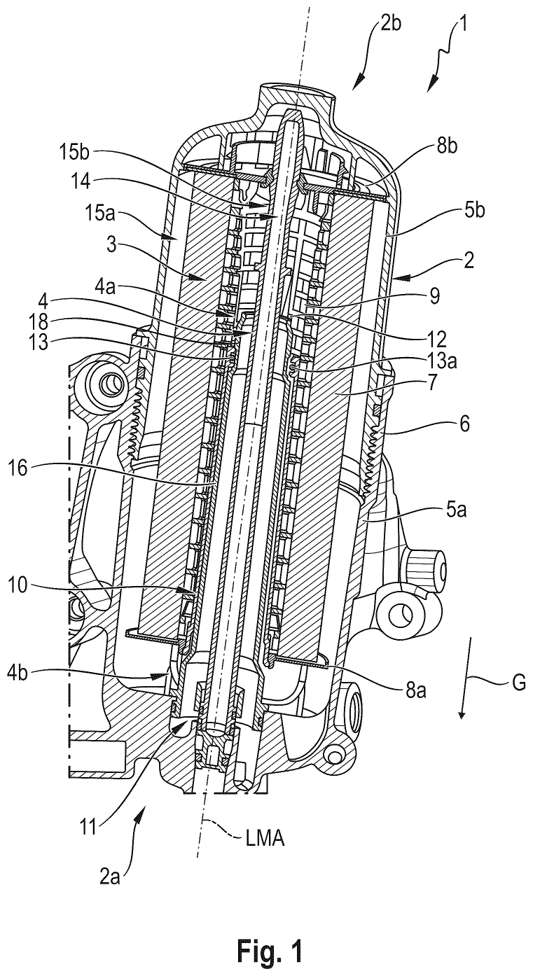

FIG. 1 shows a sectional view of a fuel filter 1 according to the invention for a motor vehicle. Fuel filter 1 comprises a housing 2, a hollow-cylindrical filter element 3, and a hollow-cylindrical outlet neck 4. In FIG. 1, the fuel filter (1) is oriented in an operational position with respect to the force of gravity (G).

The housing 2 comprises a first longitudinal end 2a and a second longitudinal end 2b, which are axially spaced apart with respect to a longitudinal central axis LMA of the housing 2. The housing 2 further comprises a first housing part 5a having the first longitudinal end 2a, and a second housing part 5b having the second longitudinal end 2b, which are detachably connected-in this case screwed together-at a circumferential connection point 6.

The filter element 3 is arranged in the housing 2 coaxially to the latter, and comprises a hollow-cylindrical filter body 7, a first and second end plate 8a and 8b, and a hollow-cylindrical support frame 9. The filter body 7 and the support frame 9 are oriented coaxially to the housing 2 and the end plates 8a and 8b are oriented transversely to the longitudinal central axis LMA of the housing. The support frame 9 is arranged inside the filter body 7 and supports the filter body 7 radially inwards. The filter body 7 and the support frame 9 extend over the entire axial height of the filter element 3 and are connected to the end plates 8a and 8b at the longitudinal ends. The end plate 8a is arranged facing the first longitudinal end and the second end plate 8b is arranged facing the second longitudinal end of the housing.

The fuel filter 1 further comprises a sealing tube 10, which is arranged inside the support frame 9 of the filter element 3 coaxially to the filter element 3. As a result, the filter body 7, the support frame 9, and the sealing tube 10 are arranged coaxially to each other and axially between the end plates 8a and 8b. The sealing tube 10 is connected to the first end plate 8a in a fluid-tight manner-welded, for example-and extends approximately over an axial center of the filter body 7. The support frame 9 is supported radially inwards on the sealing tube 10.

The outlet neck 4 is arranged in sections within the sealing tube 10 of the filter element 3 and is aligned coaxially with the housing 2 and the filter element 3. The outlet neck 4 protrudes from the sealing tube 10 at its first axial end 4a in the direction of the first longitudinal end 2a of the housing 2 and at its second axial end 4b in the direction of the second longitudinal end 2b of the housing 2. At the first end 4a, the outlet neck 4 is in fluid communication with an outlet 11 of the housing 2 formed at the first longitudinal end 2a. At its second axial end 4b, the outlet neck 4 comprises an inlet opening 12, which leads from an interior of the filter element 3 into the outlet neck 4.

The sealing tube 10 bears externally against the outlet neck 4, such that a circumferential sealing seat 13 is formed between the sealing tube 10 and the outlet neck 4. An annular ring seal 13a is arranged at the sealing seat 13 between the outlet neck 4 and the sealing tube 10, which seals the sealing seat 13. A vent tube 14 of the fuel filter 1 is also arranged coaxially inside the outlet neck 4. The vent tube 14 connects the outlet 11 of the housing 2 at the first longitudinal end 2a of the housing to the environment at the second longitudinal end 2b of the housing 2.

The fuel filter 1 is configured to filter a fuel. The fuel flows into an unfiltered fluid space 15a of the housing 2 on the unfiltered side, and through the filter body 7 of the filter element 3 into a filtered fluid space 15b of the housing 2 on the filtered side. Here, the unfiltered fluid space 15a of the housing 2 comprises an area surrounding the filter element 3 and an area arranged between the first longitudinal end 2a of the housing 2 and the end plate 8a. The filtered fluid space 15b of the housing 2 on the filtered side is located in the interior of the filter element 3. The filtered fluid space 15b is in fluid communication with the outlet 11 of the housing 2 via the inlet opening 12 of the outlet neck 4.

The fuel filter 1 further comprises an annular cavity 16, which is arranged between the sealing tube 10 and the outlet neck 4, and extends axially between the first end plate 8a and the sealing seat 13. The cavity 16 is in fluid communication with the unfiltered fluid space 15a. In order to reduce the dead volume of the cavity 16, the radial distance between the outlet neck 4 and the sealing tube 10 is minimized.

The outlet neck 4 comprises an axial groove 17-see FIG. 3-w hich faces the sealing tube 10. The groove 17 extends axially from the first longitudinal end 2a of the housing 2 or from the first end plate 8a of the filter element 3 to the sealing seat 13. The groove 17 may prevent a vacuum/air-lock effect between the outlet neck 4 and the sealing tube 10 or in the cavity 16. It is understood that several grooves 17 may also be provided, which may be arranged distributed around the longitudinal central axis LMA of the housing 2 on the outlet neck 4.

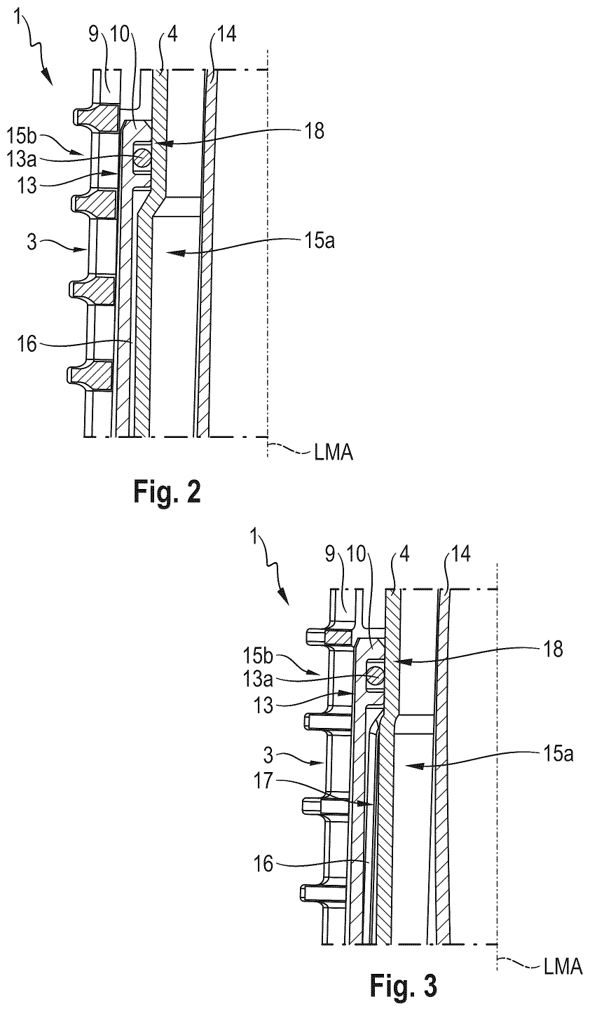

FIG. 2 and FIG. 3 show sectional views of the fuel filter 1 according to the invention in the region of the sealing seat 13. In FIG. 2, the section is taken outside the groove 17, and in FIG. 3, the section is taken through the groove 17. As can be seen particularly clearly in FIG. 2, the radial distance between the outlet neck 4 and the sealing tube 10 and thus the dead volume in the cavity 16 or between the outlet neck 4 and the sealing tube 10 is reduced. As can be seen particularly clearly in FIG. 3, the axial groove 17 leads from the sealing point 13 to the first longitudinal end 2a of the housing 2 or to the first end plate 8a of the filter element 3, such that a vacuum/air-lock effect in the cavity 16 is prevented.

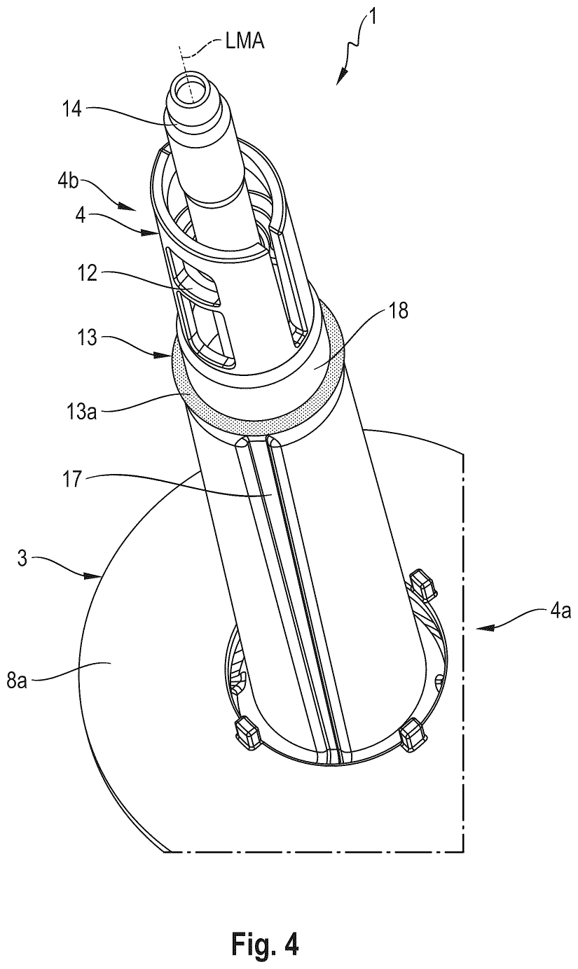

FIG. 4 shows a view of the fuel filter 1 according to the invention without the housing 2 and partially without the filter element 3. In FIG. 4, only the first end plate (8a) of the filter element (3) is visible. As can be seen in FIG. 4, the groove 17 leads from the sealing seat 13 to the first longitudinal end 2a of the housing 2 or to the first end plate 8a of the filter element 3, such that the fuel may escape from the cavity 16 into the unfiltered fluid space 15a, and the vacuum/air-lock effect in the cavity 16 may be prevented.

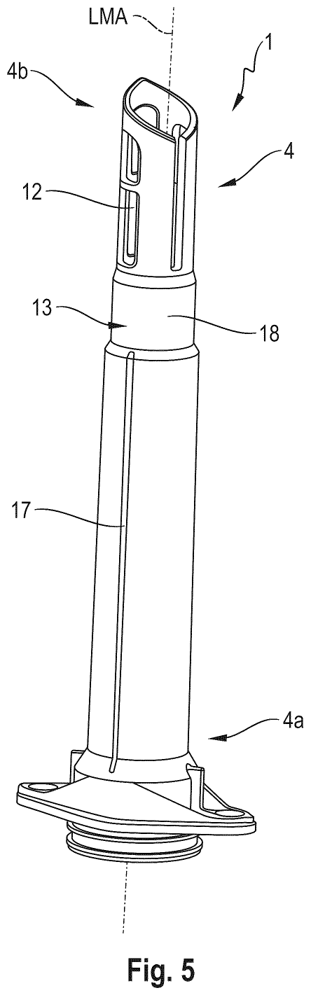

FIG. 5 shows a view of the outlet neck 4 of the fuel filter 1 according to the invention. As can be seen particularly clearly in FIG. 5, the groove 17 extends axially and is axially spaced from the inlet opening 12 of the outlet neck 4. As a result, a circumferential flat sealing region 18 is formed on the outlet neck 4 between the inlet opening 12 and the groove 17. In the sealing region 18, the sealing tube 10 is in sealing contact with the outlet neck 4, such that the sealing seat 13 described above is formed between the outlet neck 4 and the sealing tube 10.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A fuel filter for a motor vehicle, comprising:
a housing having an axial first longitudinal end, an axial second longitudinal end, and a longitudinal central axis;
a hollow-cylindrical filter element arranged in the housing coaxially to the housing;
a hollow-cylindrical outlet neck arranged in the filter element coaxially to the filter element; and
a sealing tube arranged between the filter element and the outlet neck coaxially to the outlet neck;
wherein the sealing tube is fluid-tightly connected to the filter element at the first longitudinal end of the housing and bears in a fluid-tight manner against the outlet neck at an axial distance from the first longitudinal end of the housing;
wherein the housing includes an outwardly leading outlet disposed at the first longitudinal end;
wherein the outlet neck, at the first longitudinal end of the housing, is fluidically connected to the outlet; and
wherein the outlet neck includes at least one axially extending groove facing the sealing tube.

2. The fuel filter according to claim 1, further comprising an annular cavity formed between the sealing tube and the outlet neck, wherein the at least one groove extends over at least 25% of an axial height of the annular cavity.

3. The fuel filter according to claim 2, wherein the at least one groove extends over 100% of the axial height of the annular cavity.

4. The fuel filter according to claim 1, wherein the at least one groove includes a plurality of grooves arranged on the outlet neck distributed around the longitudinal central axis of the housing.

5. The fuel filter according to claim 4, wherein the plurality of grooves are arranged evenly distributed around the longitudinal central axis of the housing.

6. The fuel filter according to claim 4, wherein at least some of the plurality of grooves are identical to each other.

7. The fuel filter according to claim 1, further comprising:
an unfiltered fluid space formed between the housing and the filter element, the unfiltered fluid space surrounding the filter element at least on an outside; and
an annular cavity formed between the sealing tube and the outlet neck, the annular cavity in fluid communication with the unfiltered fluid space at the first longitudinal end of the housing.

8. The fuel filter according to claim 1, wherein:
the outlet neck further includes an inlet opening facing away from the first longitudinal end of the housing; and
the sealing tube is in fluid-tight contact with the outlet neck between the inlet opening and the first longitudinal end of the housing.

9. The fuel filter according to claim 1, further comprising a ring seal, wherein:
the sealing tube bears in a sealing manner against the outlet neck in a circumferential sealing region of the outlet neck forming a sealing seat between the sealing tube and the outlet neck; and
the ring seal seals the sealing seat.

10. The fuel filter according to claim 9, wherein the at least one groove of the outlet neck extends axially to the sealing seat.

11. The fuel filter according to claim 1, wherein:
the outlet neck includes a first conical region disposed adjacent to the first longitudinal end of the housing and a second conical region disposed axially spaced apart from the first conical region relative to the longitudinal central axis; and
the at least one groove is disposed partially in the first conical region, disposed partially in the second conical region, and extends axially from the first conical region to the second conical region.

12. The fuel filter according to claim 2, wherein the at least one groove extends over at least 50% of the axial height of the annular cavity.

13. The fuel filter according to claim 12, wherein the at least one groove extends over at least 75% of the axial height of the annular cavity.

14. The fuel filter according to claim 4, wherein the plurality of grooves are disposed evenly spaced apart from one another in a circumferential direction extending around the longitudinal central axis.

15. The fuel filter according to claim 4, wherein at least some of the plurality of grooves have:
an identical length defined in an axial direction relative to the longitudinal central axis;
an identical width defined in a circumferential direction relative to the longitudinal central axis;
an identical depth defined in a radial direction relative to the longitudinal central axis; and/or
an identical cross-section oriented transversely to the longitudinal central axis.

16. The fuel filter according to claim 7, wherein the annular cavity is a dead volume.

17. The fuel filter according to claim 8, wherein the inlet opening opens radially relative to the longitudinal central axis.

18. The fuel filter according to claim 9, wherein the ring seal is arranged at least partially within an annular recess of the sealing tube.

19. The fuel filter according to claim 9, wherein:
the outlet neck has a first region and a second region disposed on axially opposite sides of the sealing region of the outlet neck; and
an outer diameter of the sealing region of the outlet neck is smaller than an outer diameter of the first region and is larger than an outer diameter of the second region.

20. The fuel filter according to claim 19, wherein:
the first region of the outlet neck is disposed adjacent to the first longitudinal end of the housing; and
the outlet neck further includes at least one inlet opening disposed in the second region and extending radially through the outlet neck.
